(19) United States
(12) Patent Application Publication
(10) Pub. No.: US 2025/0113804 A1
(43) Pub. Date: Apr. 10, 2025

(54) Animal Nail Polisher

(71) Applicant: Shenzhen Nalanqing Electronic Commerce Co., Ltd., Shenzhen, Guangdong (CN)

(72) Inventor: Jiying ZHANG, Shenzhen (CN)

(73) Assignee: Shenzhen Nalanqing Electronic Commerce Co., Ltd., Shenzhen, Guangdong (CN)

(21) Appl. No.: 18/506,079

(22) Filed: Nov. 9, 2023

(30) Foreign Application Priority Data
Oct. 9, 2023 (CN) 2023226987160

(51) Int. Cl. A01K 13/00; A45D 29/05

(52) U.S. Cl. CPC A01K 13/00; A45D 29/05

(57) ABSTRACT

The application discloses an animal nail polisher. The animal nail polisher includes a housing, a motor is mounted inside the housing, and a battery mounted inside the housing is arranged below the motor; an output end of the motor is connected with a rotating shaft, and an end portion of the rotating shaft is provided with a polishing head for nail polishing; a limiting sleeve is sheathed outside the polishing head, and the limiting sleeve is fixed to a top portion of the housing by a clamping mode; and a top portion of the limiting sleeve is provided with a first gap, and one side of the limiting sleeve is provided with a second gap. The nail polisher of the application is small in size, convenient to use, and may be used for different nails. The nail polisher may make the shape of the polished nail more rounded and beautiful

### CROSS-REFERENCE TO RELATED APPLICATIONS

This application claims priority to Chinese Patent Application No. 202322698716.0, filed on Oct. 9, 2023, which are incorporated herein by reference in their entirety.

### TECHNICAL FIELD

The application relates to the technical field of nail polishers, in particular to an animal nail polisher.

### BACKGROUND

A nail polisher is a product that uses electricity as energy to polish nails. The existing nail polisher has a housing and a polishing head connected to the housing.

However, the existing animal nail polisher usually adopts manual nail cutting, and it is inconvenient to operate. Therefore, it is necessary to propose a further solution scheme in response to the above problem.

### SUMMARY

A purpose of the application is to provide an animal nail polisher, as to solve the above problem proposed in the background.

In order to achieve the above purpose, the application provides the following technical schemes: an animal nail polisher includes a housing, a motor is mounted inside the housing, and a battery mounted inside the housing is arranged below the motor; and an output end of the motor is connected with a rotating shaft, and an end portion of the rotating shaft is provided with a polishing head for nail polishing.

A limiting sleeve is sheathed outside the polishing head, and the limiting sleeve is arranged at an end portion of the housing; and a top portion of the limiting sleeve is provided with a first gap, and one side of the limiting sleeve is provided with a second gap.

Furthermore, a top portion of the housing is provided with a plurality of light emitting diode (LED) lamps, and the LED lamps are electrically connected with the battery.

Furthermore, the motor is electrically connected with the battery.

Furthermore, the top portion of the housing is provided with a cover body, both sides of the top portion of the housing are provided with locking grooves, locking blocks are mounted on inner walls of both sides of the cover body, and the locking blocks are matched with the locking grooves.

Furthermore, one side of the housing is provided with a motor switch and a lighting switch, and the motor switch and the lighting switch may be rectangular, circular, or other shapes.

Furthermore, the housing includes two semicircular housing bodies, and the two semicircular housing bodies are fixedly connected or clamping-connected.

Furthermore, the polishing head is a cylindrical polishing head, and the surface of the polishing head is a rough surface formed by a sandblasting process.

Furthermore, a convex rib is arranged in the locking groove, and the locking block is provided with a limiting protrusion abutted against the convex rib.

Furthermore, the animal nail polisher further includes a control module, the control module includes a first metal oxide semiconductor (MOS) transistor, a second triode, a third triode, a first potentiometer, a second operational amplifier, a first resistor, a second resistor, a third resistor, a fourth resistor, a fifth resistor, a sixth resistor, a seventh resistor, an eighth resistor, a first capacitor, a first connection pin, a first button, and a second button. One end of the first resistor is connected with one end of the second resistor and a drain electrode of the first MOS transistor, a source electrode of the first MOS transistor is connected with one end of the third resistor and a pin 5 of the first potentiometer, a grid electrode of the first MOS transistor is connected with one end of the fourth resistor and one end of the first button, a pin 3 of the first potentiometer is connected with one end of the fifth resistor, the other end of the fifth resistor is connected with a collector electrode of the second triode, a base electrode of the second triode is connected with one end of the second button, a pin 12 of the first potentiometer is connected with an emitter electrode of the third triode, a pin 11 and a pin 10 of the first potentiometer are connected with one end of the sixth resistor, an inverting end of the second operational amplifier, and one end of the first capacitor, an non-inverting end of the second operational amplifier is connected with one end of the seventh resistor and one end of the eighth resistor, an output end of the second operational amplifier is connected with the first connection pin, the other end of the eighth resistor, a collector electrode of the third triode, the other end of the first button, and the other end of the first resistor are connected with a power supply, the other end of the second resistor, the other end of the third resistor, an emitter electrode of the second triode, the other end of the sixth resistor, the other end of the seventh resistor, the other end of the first capacitor, and a pin 6 and a pin 14 of the first potentiometer are connected with a grounding terminal.

Furthermore, the control module further includes a fourth triode, a fifth MOS transistor, a sixth MOS transistor, a seventh MOS transistor, a third operational amplifier, a fourth operational amplifier, a fifth operational amplifier, a ninth resistor, a tenth resistor, an eleventh resistor, a twelfth resistor, a thirteenth resistor, a fourteenth resistor, a fifteenth resistor, a sixteenth resistor, a seventeenth resistor, a eighteenth resistor, a second capacitor, a first diode, a second diode, and a third diode. An emitter electrode of the fourth triode is connected with one end of the twenty-second resistor, a base electrode of the fourth triode is connected with a source electrode of the fifth MOS transistor and a pin 4 of the first potentiometer, a drain electrode of the fifth MOS transistor is connected with one end of the ninth resistor and one end of the tenth resistor, a grid electrode of the fifth MOS transistor is connected with a pin 1 of the third operational amplifier and a positive electrode of the first diode, a pin 2 of the third operational amplifier is connected with one end of the eleventh resistor, one end of the twelfth resistor, and a negative electrode of the third diode, a positive electrode of the third diode is connected with a source electrode of the sixth MOS transistor, a grid electrode of the sixth MOS transistor is connected with a pin 1 of the fourth operational amplifier, a drain electrode of the sixth MOS transistor is connected with one end of the seventeenth resistor and one end of the eighteenth resistor, a pin 3 of the third operational amplifier is connected with a negative electrode of the second diode, a negative electrode of the first diode, one end of the thirteenth resistor, and one end of the fourteenth resistor, a positive electrode of the second diode is connected with a source electrode of the seventh MOS transistor, a drain electrode of the seventh MOS transistor is connected with one end of the fifteenth resistor and one end of the sixteenth resistor, a grid electrode of the seventh MOS transistor is connected with a pin 1 of the fifth operational amplifier, a pin 3 of the fifth operational amplifier is connected with one end of the nineteenth resistor and one end of the twentieth resistor, a pin 2 of the fifth operational amplifier is connected with one end of the second capacitor, one end of the twenty-first resistor, the other end of the twenty-second resistor, and a pin 3 of the fourth operational amplifier, a pin 2 of the fourth operational amplifier is connected with one end of the eighth resistor, the other end of the nineteenth resistor, the other end of the tenth resistor, the other end of the fourteenth resistor, the other end of the fifteenth resistor, and the other end of the twelfth resistor are connected with the power supply, the other end of the second capacitor, the other end of the twentieth resistor, the other end of the twenty-first resistor, the other end of the thirteenth resistor, the other end of the eleventh resistor, the other end of the sixteenth resistor and the other end of the seventeenth resistor are connected with the grounding terminal.

Compared with existing technologies, the beneficial effects of the application are as follows.

The application replaces manual nail cutting. The nail polisher of the application is small in size, convenient to use, and may be used for different nails. At the same time, the nail polisher may make the shape of the polished nail more rounded and beautiful.

The application is controlled by the control module, and the LED lamps are turned on by the lighting switch. At the same time, the motor is started by the motor switch, the motor drives the polishing head to rotate by the rotating shaft, and the polishing head polishes the animal nails at different positions by the first gap and the second gap.

### BRIEF DESCRIPTION OF THE DRAWINGS

FIG. 1 is a schematic diagram of a section-view structure of the application;

FIG. 2 is a schematic diagram of a top-view structure of the application;

FIG. 3 is a schematic diagram of a front-view structure of the application;

FIG. 4 is a structure schematic diagram of a cover body of the application;

FIG. 5 is a partial stereostructure schematic diagram of a limiting sleeve of the application; and

FIG. 6 is a structure schematic diagram of a control module of the application.

### DETAILED DESCRIPTION OF THE EMBODIMENTS

Technical schemes in embodiments of the application are clearly and completely described below in combination with drawings in the embodiments of the application. Apparently, the embodiments described are only a part of the embodiments of the application, not all of the embodiments. Based on the embodiments in the application, all other embodiments obtained by those of ordinary skill in the art without creative labor shall fall within the scope of protection of the application.

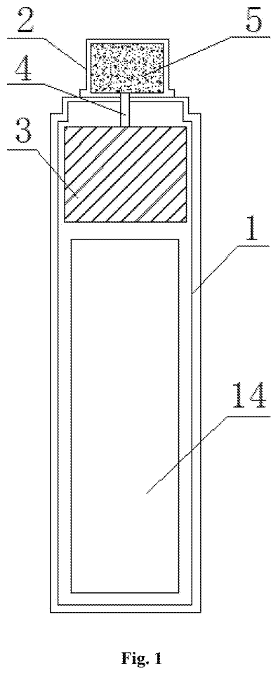

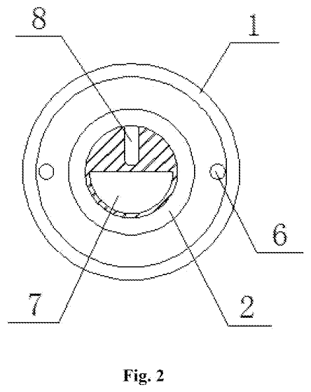

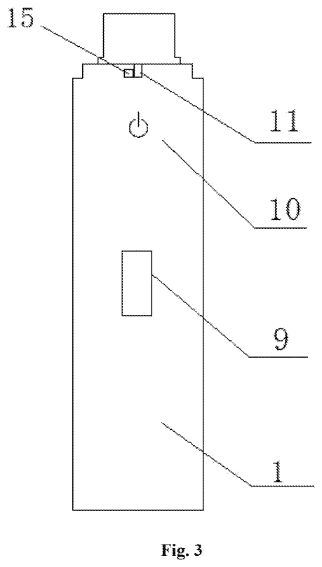

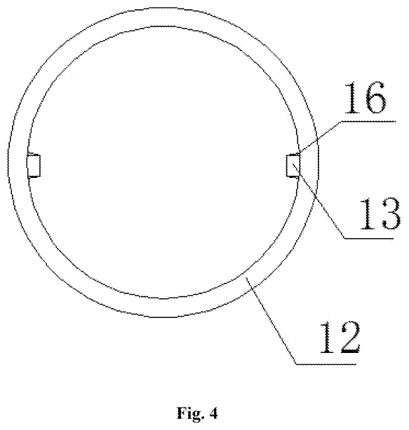

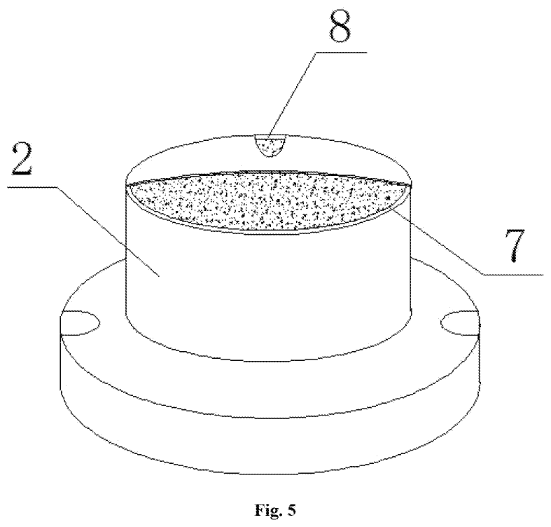

Please refer to FIGS. 1-5, the application provides a technical scheme: an animal nail polisher includes a housing 1, a motor 3 is mounted inside the housing 1, and a battery 14 mounted inside the housing 1 is arranged below the motor 3; and an output end of the motor 3 is connected with a rotating shaft 4, and an end portion of the rotating shaft 4 is provided with a polishing head 5 for nail polishing.

A limiting sleeve 2 is sheathed outside the polishing head 5, and the limiting sleeve 2 is fixed to an end portion of the housing 1 by clamping; a top portion of the limiting sleeve 2 is provided with a first gap 7, and one side of the limiting sleeve 2 is provided with a second gap 8; and the polishing head 5 polishes the animal nails at different positions by the first gap 7 and the second gap 8, the first gap 7 is convenient for polishing the nails at end portions, and the second gap 8 may polish the nails on side surfaces.

In the application, a top portion of the housing 1 is provided with a plurality of LED lamps 6, and the LED lamps 6 are electrically connected with the battery 4.

In the application, the motor 3 is electrically connected with the battery 4.

In the application, the top portion of the housing 1 is provided with a cover body 12, both sides of the top portion of the housing 1 are provided with locking grooves 11, locking blocks 13 are mounted on inner walls of both sides of the cover body 12, and the locking blocks 13 are matched with the locking grooves 11. A convex rib 15 is arranged in the locking groove 11, and the locking block 13 is provided with a limiting protrusion 16 abutted against the convex rib 15, which is convenient to cover and protect the polishing head 5 by the cover body 12.

In the application, one side of the housing 1 is provided with a motor switch 10 and a lighting switch 9, which is convenient to start the motor 3 by the motor switch 10, and the motor 3 drives the polishing head 5 to rotate by the rotating shaft 4. The motor switch 10 and the lighting switch 9 may be rectangular, circular, or other shapes that are convenient for pressing operations (such as elliptical, U-shaped, or arc-shaped).

In the application, the housing 1 includes two semicircular housing bodies, and the two semicircular housing bodies are fixedly connected by a bolt or clamping-connected, which is convenient for disassembly and assembly of the nail polisher.

In the application, the polishing head 5 is a cylindrical polishing head, and the surface of the polishing head 5 is a rough surface formed by a sandblasting process. For example, the polishing head 5 is a circular disc, the circular disc is a friction surface, and the friction surface is provided with a plurality of protrusions and depressions formed by the sandblasting process.

In the application: during use, the LED lamps 6 are turned on by the lighting switch 9, and at the same time, the motor 3 is started by the motor switch 10. The motor 3 drives the polishing head 5 to rotate by the rotating shaft 4, and the polishing head 5 polishes the animal nails at different positions by the first gap 7 and the second gap 8. The nail polisher is small in size, convenient to use, and may be used for different nails. At the same time, the nail polisher may make the shape of the polished nail more rounded and beautiful.

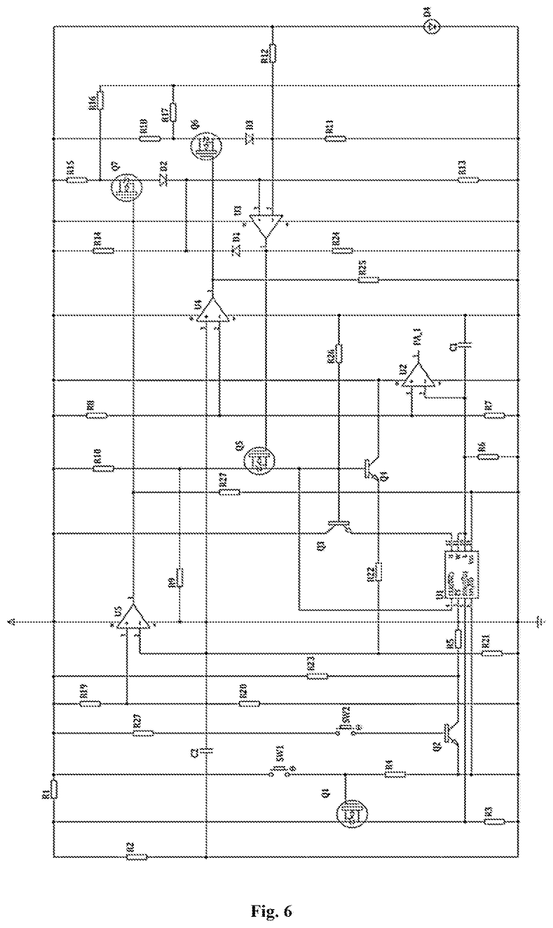

Referring to FIG. 6, herein one end of a first resistor R1 is connected with one end of a second resistor R2 and a drain electrode of a first MOS transistor Q1, a source electrode of the first MOS transistor Q1 is connected with one end of a third resistor R3 and a pin 5 of a first potentiometer U1, a grid electrode of the first MOS transistor Q1 is connected with one end of a fourth resistor R4 and one end of a first button SW1, a pin 3 of the first potentiometer U1 is connected with one end of a fifth resistor R5, the other end of the fifth resistor R5 is connected with a collector electrode of a second triode Q2, a base electrode of the second triode Q2 is connected with one end of a second button SW2, a pin 12 of the first potentiometer U1 is connected with an emitter electrode of a third triode Q3, a pin 11 and a pin 10 of the first potentiometer U1 are connected with one end of a sixth resistor R6, an inverting end of a second operational amplifier U2, and one end of a first capacitor C1, an non-inverting end of the second operational amplifier U2 is connected with one end of a seventh resistor R7 and one end of an eighth resistor R8, an output end of the second operational amplifier U2 is connected with a first connection pin PA-1, the other end of the eighth resistor R8, a collector electrode of the third triode Q3, the other end of the first button SW1, and the other end of the first resistor R1 are connected with a power supply, the other end of the second resistor R2, the other end of the third resistor R3, an emitter electrode of the second triode Q2, the other end of the sixth resistor R6, the other end of the seventh resistor R7, the other end of the first capacitor C1, and a pin 6 and a pin 14 of the first potentiometer U1 are connected with a grounding terminal.

An emitter electrode of a fourth triode Q4 is connected with one end of a twenty-second resistor Q22, a base electrode of the fourth triode Q4 is connected with a source electrode of a fifth MOS transistor Q5 and a pin 4 of the first potentiometer U1, a drain electrode of the fifth MOS transistor Q5 is connected with one end of a ninth resistor R9 and one end of a tenth resistor R10, a grid electrode of the fifth MOS transistor Q5 is connected with a pin 1 of a third operational amplifier U3 and a positive electrode of a first diode D1, a pin 2 of the third operational amplifier U3 is connected with one end of an eleventh resistor R11, one end of a twelfth resistor R12, and a negative electrode of a third diode D3, a positive electrode of the third diode D3 is connected with a source electrode of a sixth MOS transistor Q6, a grid electrode of the sixth MOS transistor Q6 is connected with a pin 1 of a fourth operational amplifier U4, a drain electrode of the sixth MOS transistor Q6 is connected with one end of a seventeenth resistor R17 and one end of an eighteenth resistor R18, a pin 3 of the third operational amplifier U3 is connected with a negative electrode of a second diode D2, a negative electrode of the first diode D1, one end of a thirteenth resistor R13, and one end of a fourteenth resistor R14, a positive electrode of the second diode D2 is connected with a source electrode of a seventh MOS transistor Q7, a drain electrode of the seventh MOS transistor Q7 is connected with one end of a fifteenth resistor R15 and one end of a sixteenth resistor R16, a grid electrode of the seventh MOS transistor Q7 is connected with a pin 1 of a fifth operational amplifier U5, a pin 3 of the fifth operational amplifier U5 is connected with one end of a nineteenth resistor R19 and one end of a twentieth resistor R20, a pin 2 of the fifth operational amplifier U5 is connected with one end of a second capacitor C2, one end of a twenty-first resistor R21, the other end of the twenty-second resistor R22, and a pin 3 of the fourth operational amplifier U4, a pin 2 of the fourth operational amplifier U4 is connected with one end of an eighth resistor R8, the other end of the nineteenth resistor R19, the other end of the tenth resistor R10, the other end of the fourteenth resistor R14, the other end of the fifteenth resistor R15, and the other end of the twelfth resistor R12 are connected with the power supply, the other end of the second capacitor C2, the other end of the twentieth resistor R20, the other end of the twenty-first resistor R21, the other end of the thirteenth resistor R13, the other end of the eleventh resistor R11, the other end of the sixteenth resistor R16 and the other end of the seventeenth resistor R17 are connected with the grounding terminal.

In view of the adaptability of the diversification of the motor in the control module and avoiding the use of multi-gear speed regulation to prevent a plurality of buttons from increasing the volume, during the use, the first button SW1 is a reset switch, and the second button SW2 is a start switch. A twenty-third resistor R23 sleeps the first potentiometer U1 by the fifth resistor R5, the second button SW2 is closed during regulation, and the twenty-third resistor R23 wakes up the first potentiometer U1 by a circuit of the second triode Q2. The first potentiometer U1 is down-regulated, and at the same time, the pin 4 of the first potentiometer U1 inputs a signal PWM1, and the base electrode of the third triode Q3 inputs a signal PWM2. At the rising edge, the third triode Q3 is conducted, the signal is fed back to the first capacitor C1 by the first potentiometer U1, the electric potential of the first capacitor C1 is pulled up, and the second operational amplifier U2 outputs the signal to the first connection pin PA-1. The first connection pin PA-1 is connected with the motor. At the falling edge, the first capacitor C1 passes through a circuit of the sixth resistor R6, and the second operational amplifier U2 cuts off the output. The seventh resistor R7 and the eighth resistor R8 are used for reference potential configuration of the second operational amplifier U2. While the first potentiometer U1 is down-regulated, an integral curve of the first capacitor C1 is pulled down, and a corresponding curve of the output of the second operational amplifier U2 is changed in frequency. It should be noted that while the motor connected with the first connection pin PA-1, for example, uses an analog signal, the connection of the pin 10 and the pin 11 of the first potentiometer U1 with a subsequent circuit is removed, but the connection with the sixth resistor R6 is retained. The sixth resistor R6 is connected with the motor, to increase the adaptability of elements used and avoid the plurality of the buttons with the fixed gears from increasing the volume. In other words, while the second button SW2 is closed, stepless speed regulation is performed on the motor, and while it is reset, the first button SW1 is closed for reverse regulation.

In view of the cost of circuit construction during production, two pulse generators are required for PWM1 and PWM2. Therefore, the connection with PWM1 and PWM2 is removed, and the base electrodes of the fourth triode Q4 and the third triode Q3 are connected in parallel with the fifth MOS transistor Q5. The fifth operational amplifier U5 and the fourth operational amplifier U4 control the third operational amplifier U3 to output a signal, the nineteenth resistor R19 and the twentieth resistor R20 provide a low potential threshold reference signal for the fifth operational amplifier U5, while the eighth resistor R8 and the seventh resistor R7 provide a high potential reference signal for the fourth operational amplifier U4. In an initial state, the electric potential of the second capacitor C2 passes through a circuit of the twenty-first resistor R21, an output signal of the fifth operational amplifier U5 is fed back to the seventh MOS transistor Q7, the seventh MOS transistor Q7 is conducted, and the signal is fed back to the pin 3 of the third operational amplifier U3 by the second diode D2. The output of the third operational amplifier U3 causes the third triode Q3 to be conducted, the first potentiometer U1 is regulated once, and the fourth triode Q4 is conducted. The signal is fed back to the second capacitor C2 by the twenty-second resistor R22, and the fifth operational amplifier U5 stops outputting, The signal from the pin 1 of the third operational amplifier U3 is fed back to the pin 3 of the third operational amplifier U3 by the first diode D1, while the signal is fed back to the fifth MOS transistor Q5. The output of the third operational amplifier U3 remains unchanged, and then the signal is output by the fourth operational amplifier U4 to the sixth MOS transistor Q6, the sixth MOS transistor Q6 is conducted, and the signal is fed back to the pin 2 of the third operational amplifier U3 by the third diode D3. The output of the third operational amplifier U3 is cut off, so that the fifth MOS transistor Q5 is cut off, the first capacitor C1 passes through a circuit of the sixth resistor R6, and is controlled by a PWM signal, the volume of a printed circuit board (PCB) is reduced while its original functions are retained. In addition, a twenty-seventh resistor R27 is used for limiting a current of the second triode Q2, a twenty-sixth resistor R26 is used for pulling down a signal of the pin 4 of the first potentiometer U1 when there is no output of the fifth MOS transistor Q5, as to prevent interference, a twenty-fifth resistor R25 is used for a grid circuit of the sixth MOS transistor Q6, a twenty-fourth resistor R24 is used for a grid circuit of the fifth MOS transistor Q5, as to prevent the current, and a fourth light emitting diode D4 is used for controlling a module starting indication.

The content which is not described in detail in this description belongs to the existing technologies known to those skilled in the art. Although the embodiments of the application are shown and described already, it may be understood by those of ordinary skill in the art that a plurality of changes, modifications, replacements, and variations may be made to these embodiments without departing from the principles and spirit of the application, and the scope of the application is limited by the appended claims and equivalents thereof.

What is claimed is:

1. An animal nail polisher, comprising a housing, characterized in that a motor is mounted inside the housing, and a battery for supplying power to the motor is further arranged inside the housing; and
an output end of the motor is connected with a rotating shaft, and an end portion of the rotating shaft is provided with a polishing head for nail polishing.

2. The animal nail polisher according to claim 1, characterized in that a limiting sleeve is sheathed outside the polishing head, and the limiting sleeve is arranged at an end portion of the housing.

3. The animal nail polisher according to claim 2, characterized in that a top portion of the limiting sleeve is provided with a first gap, and one side of the limiting sleeve is provided with a second gap.

4. The animal nail polisher according to claim 1, characterized in that a top portion of the housing is provided with a plurality of light emitting diode (LED) lamps, and the LED lamps are electrically connected with the battery.

5. The animal nail polisher according to claim 1, characterized in that the motor is electrically connected with the battery.

6. The animal nail polisher according to claim 1, characterized in that the top portion of the housing is provided with a cover body, both sides of the top portion of the housing are provided with locking grooves, locking blocks are mounted on inner walls of both sides of the cover body, and the locking blocks are matched with the locking grooves.

7. The animal nail polisher according to claim 1, characterized in that one side of the housing is provided with a motor switch and a lighting switch.

8. The animal nail polisher according to claim 1, characterized in that the housing comprises two semicircular housing bodies, and the two semicircular housing bodies are fixedly connected or clamping-connected.

9. The animal nail polisher according to claim 1, characterized in that the polishing head is a cylindrical polishing head, and the surface of the polishing head is a rough surface formed by a sandblasting process.

10. The animal nail polisher according to claim 6, characterized in that a convex rib is arranged in the locking groove, and the locking block is provided with a limiting protrusion abutted against the convex rib.
